(19) United States
(12) Patent Application Publication
(10) Pub. No.: US 2024/0383008 A1
(43) Pub. Date: Nov. 21, 2024

(54) BIN OUTPUT EXPANDER DEVICES, SYSTEMS, AND METHODS

(71) Applicant: DMT Solution Global Corporation, Danbury, CT (US)

(72) Inventors: Mohammed Islam, Ellicott City, MD (US); Robert Louis Stone, Laurel, MD (US)

(21) Appl. No.: 18/667,133

(22) Filed: May 17, 2024

Related U.S. Application Data
(60) Provisional application No. 63/467,127, filed on May 17, 2023.

(51) Int. Cl. B07C 3/08; B07C 3/00; B07C 5/34; B07C 5/36

(52) U.S. Cl. CPC B07C 3/08; B07C 3/008; B07C 5/3404; B07C 5/362

(57) ABSTRACT

The present invention is directed to devices, systems, and methods for automating parcel handling.

### CROSS-REFERENCE TO RELATED APPLICATIONS

This application claims priority to, and the benefit of, U.S. Provisional Application No. 63/467,127, filed May 17, 2023, the content of which is incorporated by reference herein in its entirety.

### TECHNICAL FIELD

The subject matter disclosed herein relates generally to devices, systems, and methods for sorting parcels. More particularly, the subject matter disclosed herein relates to devices, systems, and methods for automating parcel handling.

### BACKGROUND

In the field of parcel sorting, a high number of outputs is desirable for users, but providing such a feature typically takes too much floor space or too many diverts on the parcel sorter for a customer to accept. In addition, an increased number of outputs can also correspondingly require a high labor to receive the full containers and exchange for empties during the full day of sorting activities. For example, typical sorters will divert product (i.e., parcels, flats, mail) to a directed divert chute or output.

Accordingly, it would be desirable for devices, systems, and methods for sorting parcels to effectively increase the number of sort outputs without significantly increasing the amount of space required or the amount of labor required to manage the increased outputs.

### SUMMARY

In accordance with this disclosure, devices, systems, for sorting parcels are provided. In one aspect, a method for sorting parcels includes receiving one or more parcel from a parcel sorter and diverting each of the one or more parcel to one of a plurality of sorting containers.

In another aspect, a bin multiplexing system is provided. The system can include a conveyor belt configured for receiving one or more parcel from a parcel sorter, one or more diverter mechanism configured to move the one or more parcel from the conveyor belt, and a plurality of sorting containers configured to receive the one or more parcel from the conveyor.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a perspective top view of a bin multiplexing system with an output consolidation assembly consistent with one embodiment of the present disclosure.

FIGS. 2A and 2B are perspective side views of various positions of an adjustable flap for a bin multiplexing system consistent with one embodiment of the present disclosure.

FIG. 3 is a top view of a stacked configuration of a bin multiplexing system consistent with one embodiment of the present disclosure.

FIG. 4 is a top view of a staggered container arrangement of a bin multiplexing system consistent with one embodiment of the present disclosure.

FIG. 5 is a top perspective view of an array of staggered containers consistent with one embodiment of the present disclosure.

FIG. 6 is a schematic diagram illustrating a moving pod that is configured to replace accumulation bins for a bin multiplexing system consistent with one embodiment of the present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

The present subject matter provides systems and methods for augmenting a standard parcel sorter in order to effectively increase the number of sort outputs, allow for an in-line double-sorting for a primary and a secondary pass, and provide the ability for an automated output container exchange. In one aspect, the present subject matter provides an automated handling system to be installed on the output of a typical parcel sorter. The bin output system supports a range of parcel sorters, from low to high-speed, and with the addition of the output expander it can create a high speed, fully automated parcel sorter that can sort all mail including parcels for a high number of outputs.

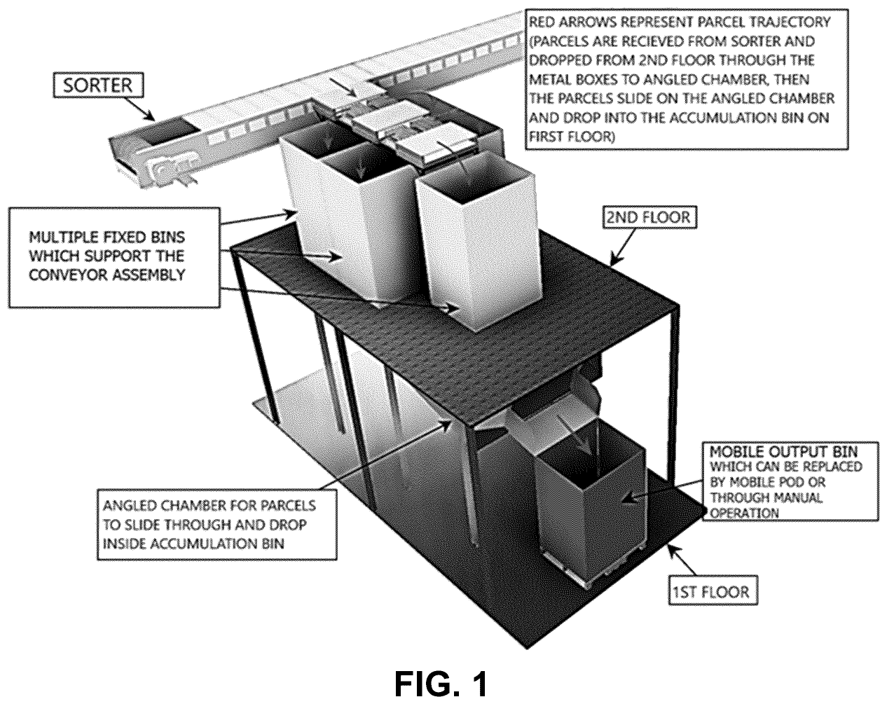

Referring to FIG. 1, a bin multiplexing system, which can be referred to as a bin expander, is shown with an output consolidation assembly. One or more bin expander can interface to most existing sorters, thereby creating high benefit to customers for expansion of existing equipment to meet growing business needs. In some embodiments, this design concept allows for maximizing sorting destination without significantly increasing the output footprint by keeping the divert-to-destination relationship 1:1. Stated otherwise, the total number of destinations supported can be equivalent to the number of divert lanes multiplied by a number of containers included at each divert lane, but the total number of output lanes is merely equal to the number of divert lanes, thus reducing the sorter footprint in any processing center. This is fast sorting with no downtime for the bin exchange because the output bin is exchanged in parallel of the operation.

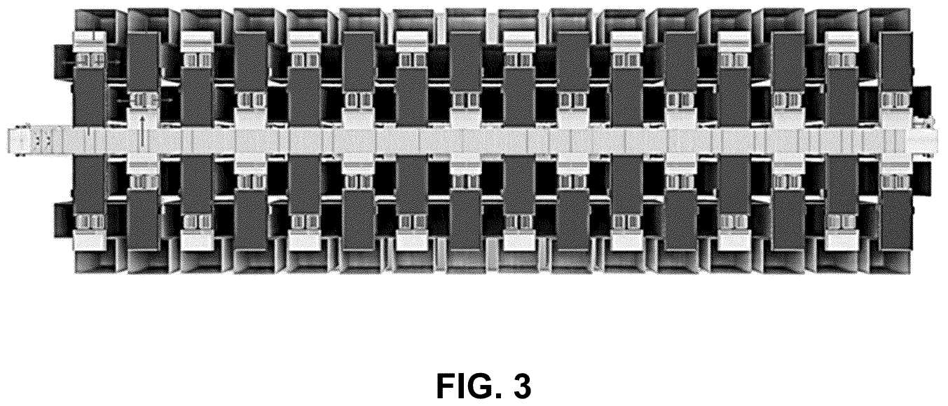

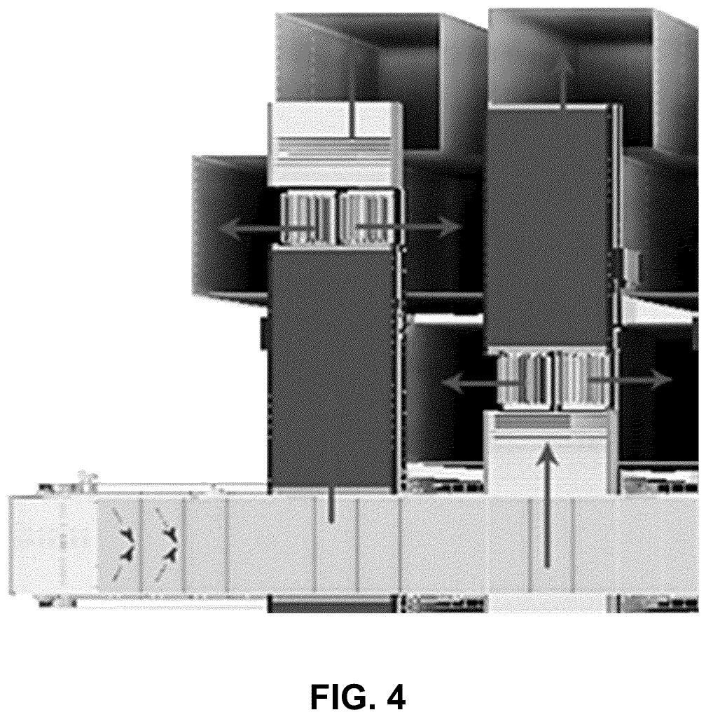

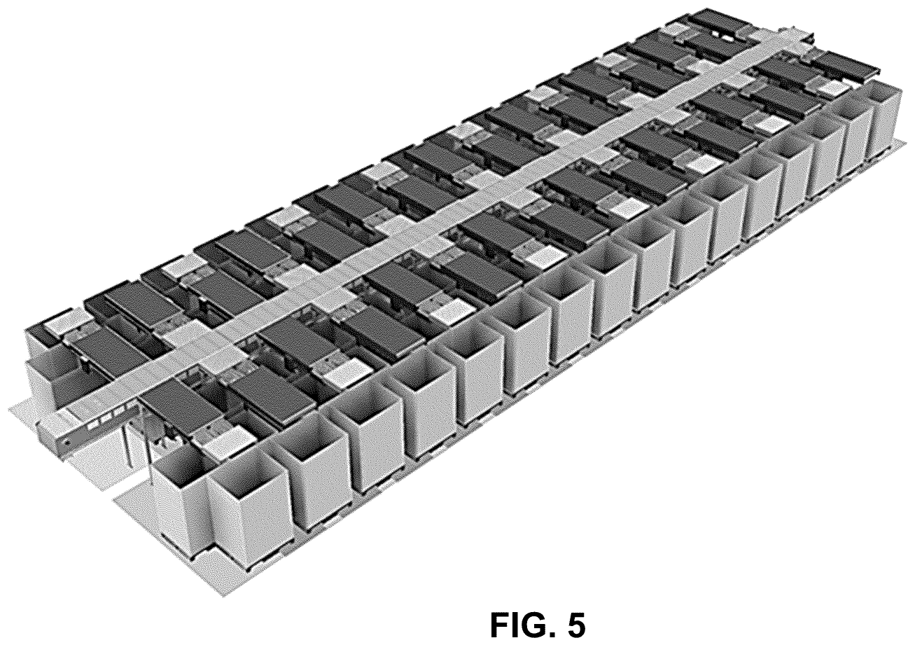

As shown in FIGS. 1 through 5, each bin expander receives parcels from the parcel sorter and delivers them into multiple bins. The parcels are sorted to a number of unique destinations by a diverting device. There can be any number of diverting devices on each lane depending on the sorting needs, creating a high number of possible output configurations. For example, in the configuration shown in FIG. 1, the bin expander supports five potentially different parcel destinations associated with the five different parcel trajectories represented by arrows. In the configurations shown in FIGS. 3 and 4, each of a plurality of bin expanders supports three different parcel destinations associated with the three different parcel trajectories represented by arrows. In some embodiments, the parcels are tracked within a sorting controller and sorting software to ensure integrity of mail piece tracking from the parcel sorter to the various destination containers. Since there are multiple bins, parcel sorting is not restricted by output bin conditions and can support sorting at a fast rate.

After the parcels are received by a bin expander, the further diversion of the parcels to output bins can be applied in two configurations. In a first configuration, parcels are sorted to a selected fixed bin arranged between the parcel sorter and the desired output. Alternatively, in a second configuration, parcels are sorted directly to an output container. Either configuration can provide similar benefits, although both have slightly different advantages to offer the end system's use case.

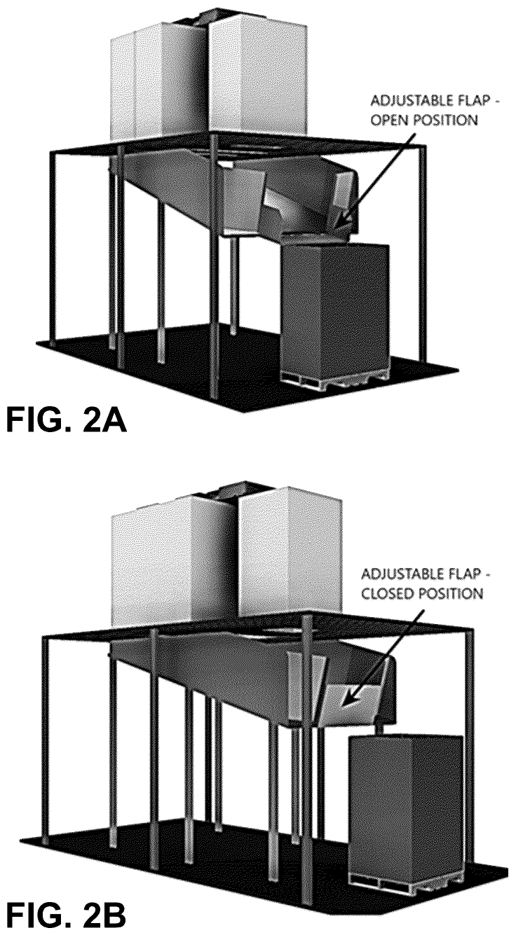

An embodiment of the first configuration for the bin output expander is shown in FIGS. 1 and 2. In this configuration, the parcels are sorted into fixed bins that are mounted in an elevated position. The fixed bins act as an intermediary holding receptacle until the final container is ready to be filled. This configuration allows for multiple bins to be connected to a single branch from the parcel sorter, where each bin can be a separate sort destination, but the multiple bins can be filled simultaneously. In some embodiments, when any of the fixed bins are ready to be discharged (i.e., bin is full, sort run is complete, etc), the products are discharged into an individual container. In some embodiments, the individual container can be a corrugated box, a roller hamper, or any of a variety of other containers configured for this purpose.

In this configuration, each of these fixed bins can represent individual sort destinations, or a mix, such that multiple different sort destinations can be sorted simultaneously to the fixed bin, and then released individually to the container. For example, the configuration illustrated in FIG. 1 provides five different sort destinations, although those having ordinary skill in the art will recognize that the number of fixed bins can be varied based on the needs of a given implementation. In any arrangement, this sorting to intermediary holding receptacles is managed by the sort controller and the internal flap control mechanism. The advantage of this configuration is that the number of output container locations is kept to a minimum despite a comparatively higher number of sort destinations (i.e., within the fixed bins), which makes the system easier for either operators to maintain or fewer locations to add automation in order to fully automated the container exchanges. The fixed bins can be any size, either generally equal to the size of the output container, or smaller. Smaller bins create an opportunity for filling a single output container from multiple bins, enabling a multiplexing opportunity on the parcel sorter for combining sort destinations that can go for a dynamic re-pass operation.

As shown in FIG. 2A, when the fixed bin is ready to release products to an output container, the parcels drop through chute or guide path by way of a stop-flap, to a container in waiting within a corral or chamber. In some embodiments, the corral is equipped with an intelligent safety interlocked flap that has sensors that allow the flap to open only when the mobile output bin is present and empty. Conversely, as shown in FIG. 2B, the flap can be configured to be closed when the mobile output bin is fully loaded or is absent to prevent discharge to an overly full container, a container full of another destination of mail, or an empty corral.

Alternatively, as shown in FIGS. 3 through 5, the second configuration can be configured such that the parcels are directed from the expander diverts directly into an output container. In this configuration, as opposed to fixed bins in the first configuration discussed above, all sort destinations are filling directly into output containers at the same time. As shown in FIGS. 3 through 5, however, the positions of the output containers can be staggered about the bin expander system to optimize the space surrounding the parcel sorter to include more outputs within substantially the same footprint. The in-line secondary sort operation offers a greater diversity of sorting options compared to conventional sorting systems while also eliminating repass operations, reducing labor, and improving speed to sort/ship.

In either configuration, the containers can be replaced by manual handlers around the sorter as is typical, or the bin output expander enables automation to be more readily applied to container exchanges (i.e., replacing a full container with an empty container in order to continue receiving parcels). Due to the size of the containers on a parcel sorter, it can be challenging and expensive to automate this process, but the bin expander system supports a less complex and less expensive option to automate the container exchanges.

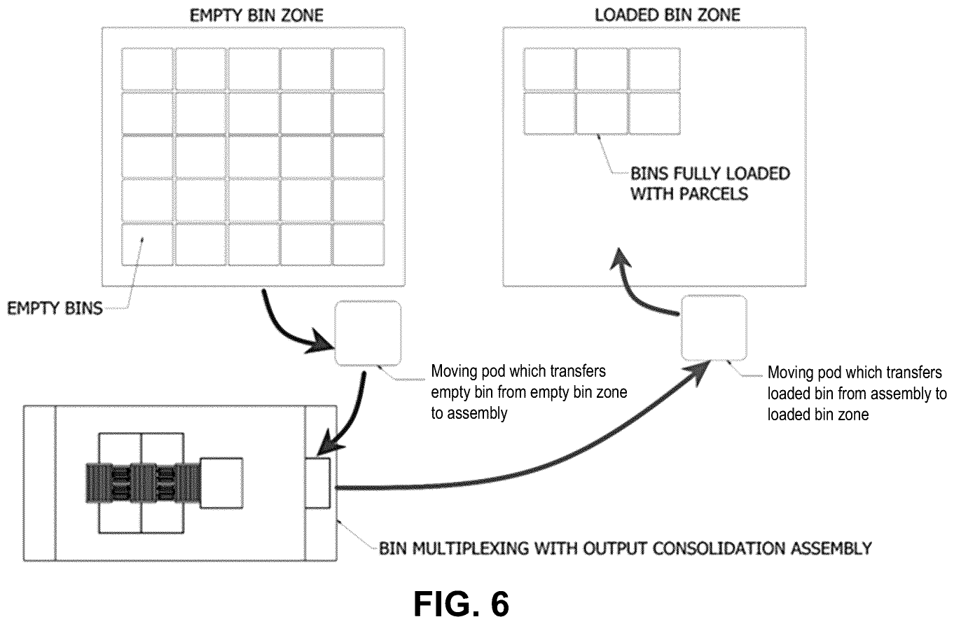

In particular, the uniqueness of the first configuration shown in FIGS. 1 and 2 allows for a comparatively simple and low cost system of container exchanges, but either configuration can be adapted such that the outputs can be exchanged automatically. In some embodiments, for example, automation can be achieved using a linear style, conveyor based, container exchange system. Alternatively or in addition, in some embodiments, the container exchanges, and also movement to queuing areas, by way of automated guided vehicles/pods can be implemented for a more comprehensive value system, such as is shown in FIG. 6. Such a fully automated version of the design uses movable pods to replace the container, thus the automated container exchange system allows for staff/personnel to avoid harsh and potentially unsafe working conditions, as warehouse staff do not have to replace the fully loaded heavy bins manually. The automated movable pod saves time and eliminates error in container locations and identifications, which is essential for warehouses sorting parcels at a rapid rate. In particular, for example, in the first configuration shown in FIGS. 1 and 2, the output containers are arranged in a desired orientation, such as the straight line orientation shown, creating an affordable option for automated container exchanges with a high number of sort point destinations.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A bin multiplexing system comprising:
a conveyor belt configured for receiving one or more parcels from a parcel sorter;
one or more diverter mechanisms configured to move the one or more parcels from the conveyor belt; and
a plurality of sorting containers configured to receive, via the one or more diverter mechanisms, the one or more parcels from the conveyor belt.

2. The bin multiplexing system of claim 1, wherein the one or more diverter mechanisms is configured to provide in-line sorting of the one or more parcel received from the parcel sorter.

3. The bin multiplexing system of claim 1, wherein the plurality of sorting containers comprises a plurality of intermediate bins and wherein the system further comprises one or more output containers configured to receive the one or more parcels from the plurality of intermediate bins.

4. The bin multiplexing system of claim 3, further comprising an angled chamber positioned between the plurality of intermediate bins and the one or more output containers, wherein the angled chamber is configured to direct the one or more parcels toward the one or more output containers.

5. The bin multiplexing system of claim 3, further comprising a stop flap mechanism positioned between the plurality of intermediate bins and the one or more output containers.

6. The bin multiplexing system of claim 5, wherein the stop flap mechanism is operable to selectively discharge the one or more parcels to the one or more output containers.

7. The bin multiplexing system of claim 6, further comprising one or more sensors configured to detect whether the one or more output containers is in one or more of a full container condition, a correct container condition, or a no container condition.

8. The bin multiplexing system of claim 7, wherein the stop flap mechanism is configured to:
temporarily store the one or more parcels in response to detection of a full container condition or a no container condition; and
discharge the one or more parcels in response to detection of a correct container condition.

9. The bin multiplexing system of claim 3, further comprising one or more automated guided vehicles configured for automatically exchanging filled ones of the one or more output containers for a respective an empty output container.

10. The bin multiplexing system of claim 1, wherein the plurality of sorting containers comprises one or more output containers.

11. A method for sorting parcels, the method comprising:
receiving one or more parcels from a parcel sorter; and
diverting each of the one or more parcels to one of a plurality of sorting containers.

12. The method of claim 11, wherein receiving the one or more parcels from the parcel sorter comprises receiving the one or more parcels at one of a plurality of bin multiplexing systems, each of the plurality of bin multiplexing systems comprising a plurality of independent sorting containers.

13. The method of claim 11, wherein:
receiving the one or more parcels from the parcel sorter comprises receiving the one or more parcels on a conveyor belt; and
wherein diverting each of the one or more parcels comprises operating one or more diverter mechanisms to move each of the one or more parcels to the one of the plurality of sorting containers.

14. The method of claim 11, wherein the plurality of sorting containers comprises a plurality of intermediate bins.

15. The method of claim 14, further comprising transferring the one or more parcels from the plurality of intermediate bins to one or more output containers.

16. The method of claim 15, further comprising detecting whether the one or more output containers is in one or more of a full container condition, a correct container condition, or a no container condition.

17. The method of claim 16, wherein transferring the one or more parcels from the plurality of intermediate bins to one or more output containers comprises:
temporarily storing the one or more parcels in response to detection of a full container condition or a no container condition; and
transferring the one or more parcels in response to detection of a correct container condition.

18. The method of claim 11, wherein diverting each of the one or more parcels to one of the plurality of sorting containers comprises transferring the one or more parcels directly to one or more output containers.

19. The method of claim 18, further comprising automatically exchanging filled output containers of the one or more output containers with empty output containers, respectively.

20. The method of claim 11, wherein diverting each of the one or more parcels comprises providing in-line sorting of the one or more parcels received from the parcel sorter.
